(19) United States
(12) Patent Application Publication
(10) Pub. No.: US 2017/0234520 A1
(43) Pub. Date: Aug. 17, 2017

(54) LIGHT EMITTING DIODE LUMINAIRE

(71) Applicant: Shenzhen Yaorong Technology Co., Ltd., Shenzhen (CN)

(72) Inventors: Huanhuan YU, Shenzhen (CN); Ying YONG, Shenzhen (CN)

(73) Assignee: Shenzhen Yaorong Technology Co., Ltd., Shenzhen (CN)

(21) Appl. No.: 15/582,721

(22) Filed: Apr. 30, 2017

Related U.S. Application Data
(63) Continuation-in-part of application No. 14/733,941, filed on Jun. 8, 2015.

(30) Foreign Application Priority Data
Jun. 9, 2014 (CN) 201420306371.8

(51) Int. Cl. F21V 29/70; F21V 5/08; F21V 15/00; F21V 31/00; F21V 23/02; F21V 5/00; F21V 29/89

(52) U.S. Cl. CPC F21V 29/70; F21V 5/007; F21V 5/08; F21V 29/89; F21V 31/005; F21V 23/02; F21V 15/00; F21Y 2115/10

(57) ABSTRACT

A Light Emitting Diode (LED) luminaire comprises a heat radiator, a power source and a plurality of LED light sources. The LED luminaire is further equipped with an adapter assembly, one end of which is fixed on the heat radiator and when in use the other end of which is fixed with the outside. The adapter assembly comprises a first adapter and a second adapter which can be rotatably engaged with each other through tooth structures formed on the two adapters; and when the two adapters are engaged to each other through the teeth structures the two adapters together form a waterproof housing. The LED luminaire further comprises a lens module board comprising a plurality of lenses covering the Light Emitting Diode light sources. The lenses comprise light distribution lenses configured to distribute light emitted from the Light Emitting Diode light sources in an asymmetric illumination profile.

### CROSS REFERENCE TO RELATED APPLICATIONS

The present application claims priority to Chinese Utility Model CN201420306371.8 filed on Jun. 9, 2014. The present application is the Continuation-in-Part of U.S. patent application Ser. No. 14733941 filed Jun. 8, 2015.

### TECHNICAL FIELD

The present invention relates to the field of luminaire and especially to an Light Emitting Diode (LED) luminaire.

### BACKGROUND ART

The structure of a typical Light Emitting Diode (LED) luminaire in the art is not convenient for air convection, nor for timely discharge of hot-air, thus suffering from poor heat dissipation.

In addition, the overall structure is fixed and it is not possible or convenient to adjust the angle of installation.

Furthermore, the lenses of the LED luminaire the art are individual ones, with a glass panel separating the lenses from the outside. Though the purpose of waterproofing is achieved, the structure is not simple.

### SUMMARY

To address the above mentioned defects, the invention provides a Light Emitting Diode luminaire with better heat dissipation effect, convenient for adjusting angle, with simple structure and good lighting effect.

To solve the above mentioned technical problems, the technical proposal used in this invention is as follows: a Light Emitting Diode luminaire, comprising a radiator, power source and a plurality of Light Emitting Diode light sources; the power source connected with the light sources electrically; the power source is installed on the radiator, the radiator is equipped with through-holes from top to bottom, facilitating air convection and heat exchange, achieving better heat dissipation effect.

To solve the above mentioned technical problems, the present invention provides a Light Emitting Diode luminaire which comprises, among others, a radiator, a power source and a plurality of Light Emitting Diode light sources, the power source electrically connected with the Light Emitting Diode light sources and installed on the radiator. The Light Emitting Diode luminaire further comprises a lens module board fixed on the bottom of the radiator. The lens module board comprises a plurality of lenses covering the Light Emitting Diode light sources. The lenses comprise light distribution lenses configured to distribute light emitted from the Light Emitting Diode light sources in an asymmetric illumination profile; for example, more light energy is concentrated on one side of the Light Emitting Diode luminaire than on another side of the Light Emitting Diode luminaire.

Preferably, the radiator is equipped with a plurality of heat sinks with a gap between two neighboring heat sinks, allowing for quick heat dissipation.

Preferably, the Light Emitting Diode luminaire is equipped with an adapter assembly, one end of the adapter assembly fixed on the radiator; and when in use, the other end of the adapter assembly is fixed with the outside, for example, on a wall.

Preferably, the adapter assembly comprises a first adapter and a second adapter; the first adapter is fixed on the radiator, and the first adapter is rotatably engaged to the second adapter, and when in use the second adapter is fixed with the outside. Preferably, the first adapter and the second adapter have tooth structures, and the two adapters are rotatably engaged with each other through the tooth structures. In other words, the tooth structures provided on the first adapter and on the second adapter allow the two engaging adapters to rotate with respect to each other, allowing for adjustment of installation angle of the Light Emitting Diode luminaire.

Preferably, the first adapter may be fixed on the radiator by a silicone pad, and the first adapter can tightly connect to the second adapter by means of a silicone ring. Preferably, when the first and second adapters are engaged with each other through the tooth structures, the first and second adapters together form a waterproof housing. Thus, the inside of the first adapter and the inside of the second adapter are protected from water and/or humidity as well as physical damage that may be caused by external objects.

Preferably, the Light Emitting Diode luminaire further comprises an aluminum substrate, on which the Light Emitting Diode light sources are all evenly distributed. The aluminum substrate may be fixed on the bottom of the radiator. The number of the lenses on the lens module board may be equal to the number of the Light Emitting Diode light sources. The lens module board covers the Light Emitting Diode light sources and is sealed by a waterproof ring.

Preferably, one lens covers one Light Emitting Diode light source. The lens module board is fixed on the bottom of the radiator. The structure adopts waterproof and optical integrated design, with simple and elegant outlook.

Preferably, the lenses on the lens module board are polarized lenses, making light scattered at a larger area.

Preferably, the material of the radiator is aluminum, copper, or the like, in order to speed up the heat dissipation.

Preferably, the power source is equipped with a lighting arrester.

Preferably, the Light Emitting Diode luminaire is provided with a fixed adapter, one end of the fixed adapter fixed on the radiator, and the other end of the fixed adapter is fixed on the outside.

Preferably, each of the Light Emitting Diode light sources is configured to emit light along a light emission axis, and at least one of the light distribution lenses is configured to distribute the light emitted from the corresponding Light Emitting Diode light source in an asymmetric illumination profile, for example, such that more light energy is concentrated on one side of the corresponding light emission axis than on another side of the corresponding light emission axis.

Compared with prior art, this invention can provide several beneficial effects, including the below:

1) The radiator of the Light Emitting Diode luminaire is equipped with through-holes from top to bottom, facilitating air convection and air exchange. It is also designed with a plurality of heat sinks with gaps in-between. All these features allow quick heat dissipation, thus achieving good heat dissipation for the Light Emitting Diode luminaire.

2) The Light Emitting Diode luminaire is equipped with an adapter assembly which comprises the first adapter and the second adapter rotatably engaged with each other, allowing for adjustment of the angle of installation of the Light Emitting Diode luminaire.

3) When engaged with each other through tooth structures, the first adapter and the second adapter together form a waterproof housing, protecting the inside of the first adapter and the inside of the second adapter; for example, from water, humidity, dust, pollution, and even damaged caused by external force.

4) The Light Emitting Diode luminaire comprises a lens module board which adopts the waterproof and optical integrated design, with simple and elegant outlook. A very good waterproof effect is achieved without using a glass board to separate the lenses from the outside.

5) In certain embodiments, the lenses comprise light distribution lenses configured to distribute light emitted from the Light Emitting Diode light sources in an asymmetric illumination profile. This can, for example, effectively illuminate certain target areas rather than other areas.

6) In certain embodiments, the lenses on the lens module board may be polarized lenses, producing polarized distribution light for large angle of lighting, achieving scattered lighting, having large lighting range.

7) The installment of a lighting arrester increases safety and improves the working life of the Light Emitting Diode luminaire.

### BRIEF DESCRIPTION OF FIGURES

FIG. 1 is a schematic diagram of a Light Emitting Diode luminaire according to an embodiment of the invention;

FIG. 2 is a decomposition diagram of a specific exemplary Light Emitting Diode luminaire according to an embodiment of the invention (only major components displayed in the figures);

FIG. 3 is a view of a Light Emitting Diode luminaire according to an embodiment of the invention;

FIG. 4 is another schematic diagram of a Light Emitting Diode luminaire according to an embodiment of the invention;

FIG. 5 is a decomposition diagram of a Light Emitting Diode luminaire according to an embodiment of the invention (only main components displayed in the figures);

FIG. 6 is a schematic diagram of a Light Emitting Diode luminaire according to an embodiment of the invention;

FIG. 7 is a view of a Light Emitting Diode luminaire according to an embodiment of the invention;

FIG. 8 is a view of a Light Emitting Diode luminaire according to an embodiment of the invention.

### DETAILED DESCRIPTION OF EMBODIMENTS

In order to better understand the invention, the invention is further described with reference to the figures and certain embodiments.

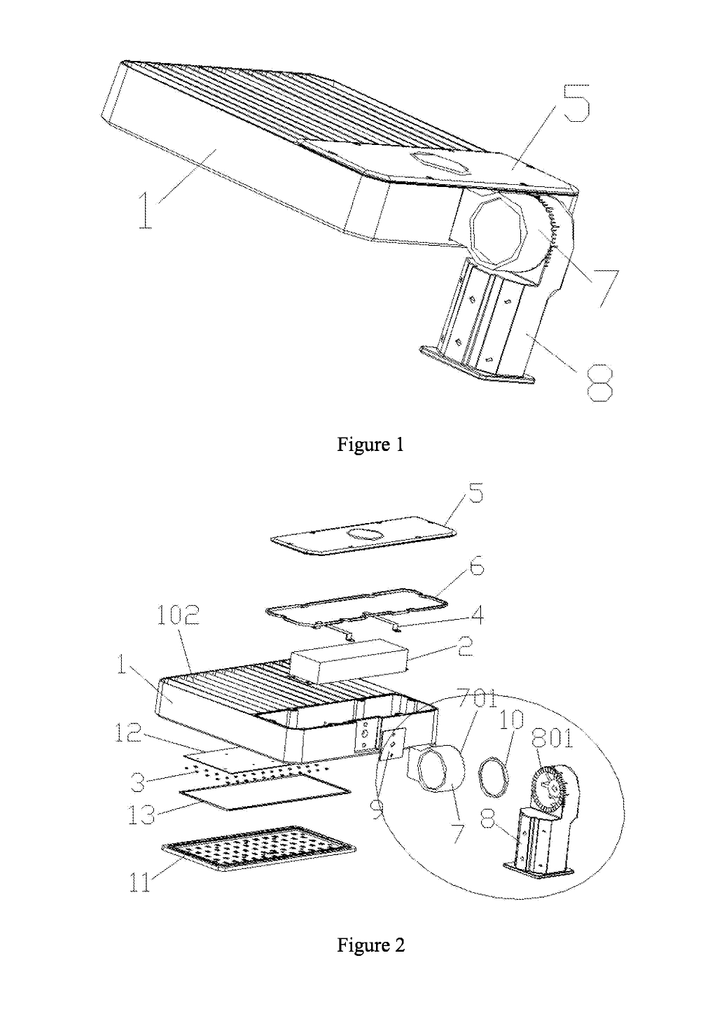

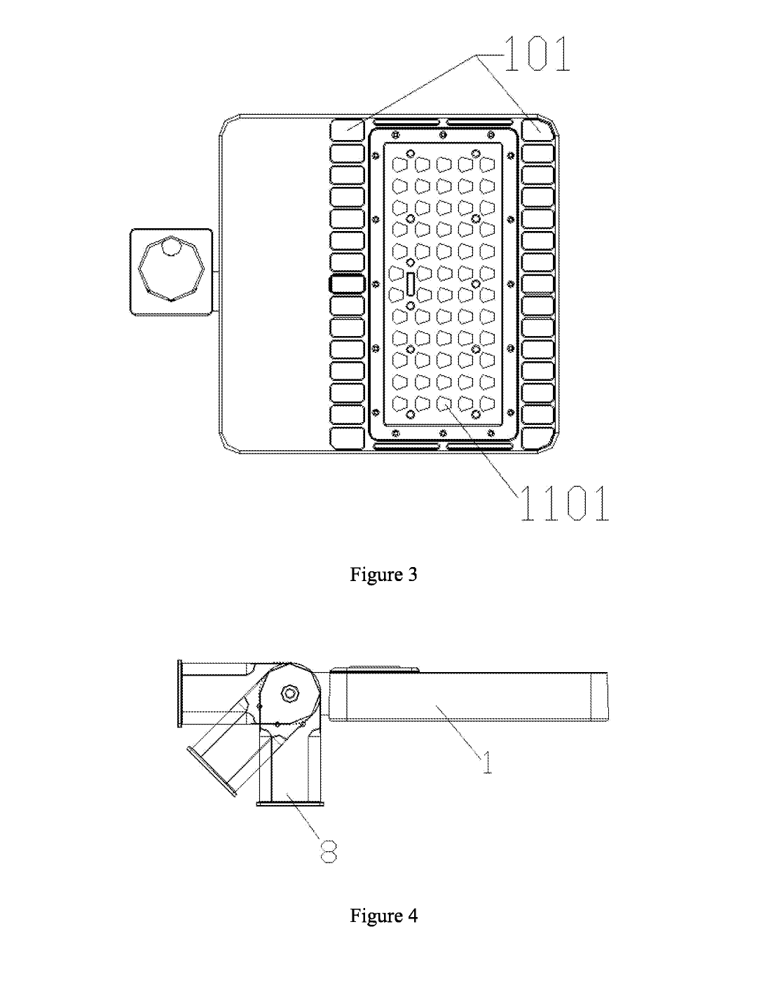

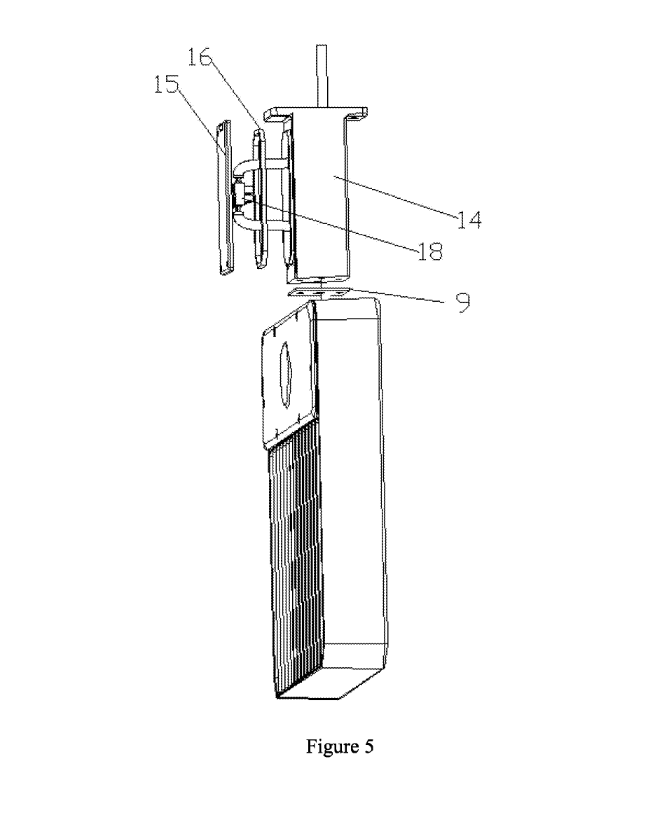

Referring to FIG. 1, FIG. 2, FIG. 3 and FIG. 4, a Light Emitting Diode luminaire comprises a radiator 1, a power source 2, and a plurality of Light Emitting Diode light sources 3. The power source 2 is electrically connected with the Light Emitting Diode light sources 3. The power source 2 is installed on the radiator 1, can be fixed by a power strip 4, and is covered by a cover of a power box 5 and a silicone ring of power box 6. The radiator 1 is equipped with through-holes 101 from top to bottom, facilitating air convection and air exchange, achieving good heat dissipation effect. The radiator 1 can have a number of heat sinks 102, with gaps in between, allowing for quick heat dissipation. The material of the radiator 1 can be aluminum or copper, for even better heat dissipation effect.

The Light Emitting Diode luminaire further comprises a lens module board 11 fixed on the bottom of the radiator 1. The lens module board 11 comprises a plurality of lenses covering the Light Emitting Diode light sources. The lenses comprise light distribution lenses configured to distribute light emitted from the Light Emitting Diode light sources in an asymmetric illumination profile. This can, for example, effectively illuminate certain target areas rather than other areas.

In one embodiment, each of the Light Emitting Diode light sources is configured to emit light along a light emission axis, wherein at least one of the light distribution lenses is configured to distribute the light emitted from the corresponding Light Emitting Diode light source such that more light energy is concentrated on a first side of the corresponding light emission axis than on a second side of the corresponding light emission axis.

The Light Emitting Diode luminaire is equipped with an adapter assembly; one end of the adapter assembly is fixed on the radiator, and when the Light Emitting Diode luminaire is in use, the other end of the adapter assembly is fixed with the outside, for example, a wall, a lamp post, a ceiling, or the like. The adapter assembly comprises a first adapter 7 and a second adapter 8; the first adapter 7 is fixed on the radiator 1, and the first adapter 7 can be rotatably engaged with the second adapter 8. When the Light Emitting Diode luminaire is in use, the second adapter 8 is fixed with the outside, for example, a wall, a lamp post, a ceiling, or the like. The first adapter 7 and the second adapter 8 have tooth structures 701, 801, and the two adapters can be engaged with each other through the tooth structures 701, 801 which can rotate with respect to each other, thereby facilitating the adjustment of installation angle of the Light Emitting Diode luminaire. The first adapter 7 is fixed on the radiator 1 by silicone pad 9. Preferably, the first adapter 7 can be tightly engaged to the second adapter 8 with help of a silicone ring 10.

As can be seen from FIG. 1, when the first adapter 7 and the second adapter 8 are engaged with each other through the tooth structures, the first adapter 7 and the second adapter 8 together form a closed structure that is waterproof. This closed structure can be seen as a waterproof housing that can protect the inside of the first adapter 7 and the inside of the second adapter 7; for example, from water, humidity, dust, pollution, and even damaged caused by external force.

The Light Emitting Diode luminaire further comprises an aluminum substrate 12; the Light Emitting Diode light sources 3 are all evenly distributed on the aluminum substrate 12, for example, uniformly distributed and welded on the aluminum substrate 12. The aluminum substrate is fixed on the bottom of the radiator 1; the number of the lenses 1101 on the lens module board 11 is equal to the number of Light Emitting Diode light sources 3; the lens module board 11 covers the Light Emitting Diode light sources 3 and is sealed by waterproof ring 13, with one lens covers one Light Emitting Diode light source; the lens module board 11 is fixed on the bottom of the radiator 1. The structure adopts waterproof and optical integrated design, with simple and elegant outlook, reaching a very good waterproof effect without using glass board to separate the lenses and the outside.

In an embodiment, the lenses 1101 on the lens module board 11 can use polarized lenses, producing polarized distribution light for large angle of lighting, achieving scattered lighting, having large lighting range.

To enhance lighting protection of the Light Emitting Diode luminaire, increase the safety and improve the working life of the Light Emitting Diode luminaire, the power source 2 can be equipped with a lighting arrester (not shown in the figure).

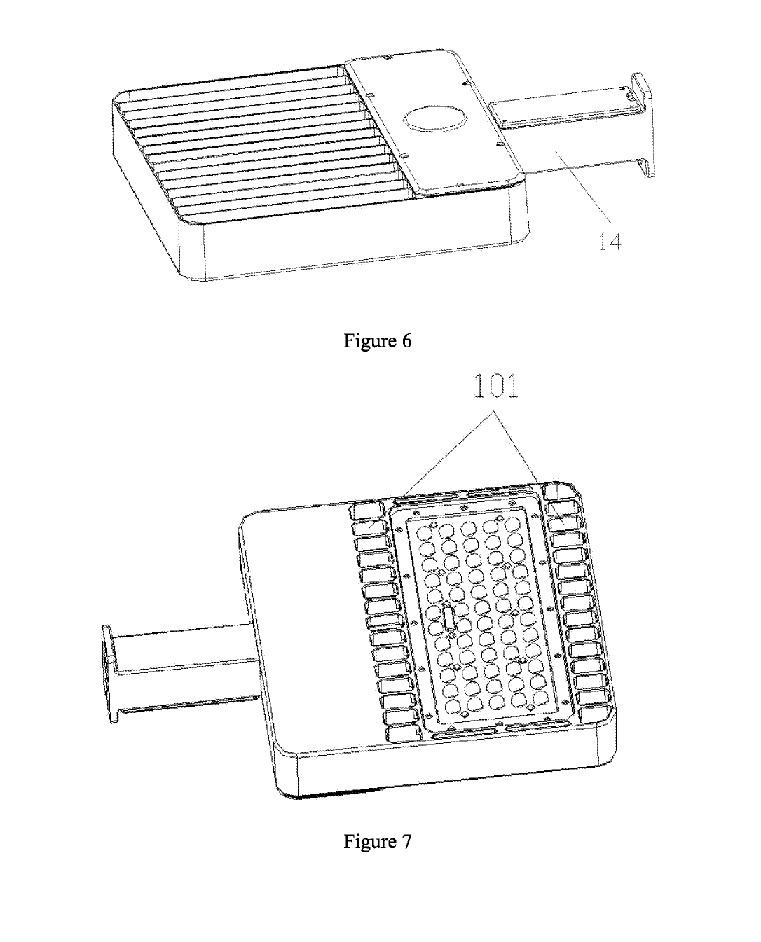

Reference is made to FIGS. 5 and 6; the Light Emitting Diode luminaire can be fixed to the outside such as a wall, lamp post, etc. without the rotatable adapters; instead the Light Emitting Diode luminaire is connected to the outside with a fixed adapter 14, the fixed adapter is not a rotating one. The fixed adapter 14 holds down the silicone pad of the adapter and fixes on the radiator 1.

Reference is made to FIG. 5; the fixed adapter 14 can be provided with a connection cover 15, under which a binding post 18 is set for connecting cables, facilitating the connection to external power supplies. The connection cover 15 holds down the silicone ring 16 of the cover and sits on the fixed adapter 14.

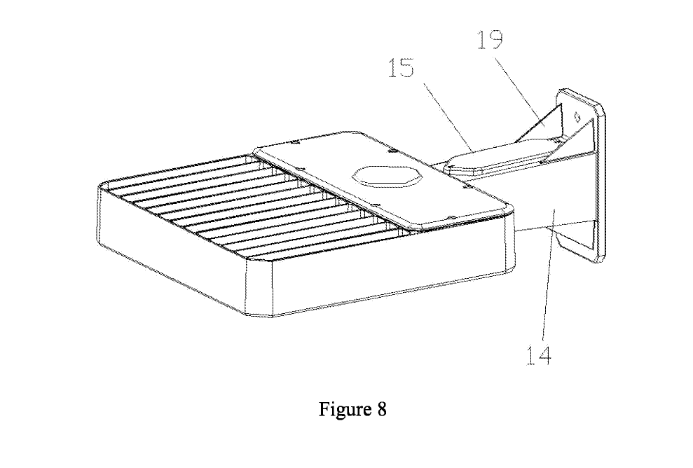

The connection cover 15 shown in FIGS. 5 and 6 is a square cover plate. FIG. 8 shows a new structure formed after simple change of the fixed adapter 14, its connection cover 15 is square in the center and triangle at both sides. At the end where the fixed adapter 14 is fixed to the outside, there is set one or more reinforced ribs so as to enhance the connection to the outside.

This Light Emitting Diode luminaire according to the present invention features good heat dissipation effect and it is easy for adjusting the installation angle. It adopts the waterproof and optical integrated design, with simple structure, good waterproof effect, wide lighting range, high safety and long service life.

The description above is only better embodiments of the invention, and is not used to limit this invention. It should be pointed out that for ordinary technicians in this field, any modification, equivalent replacement and improvement within the spirits and principles of the invention hereof shall fall into the protective range of the invention.

What is claimed is:

1. A Light Emitting Diode luminaire comprising a radiator, a power source and a plurality of Light Emitting Diode light sources, the power source electrically connected with the Light Emitting Diode light sources and installed on the radiator;
wherein the Light Emitting Diode luminaire further comprises a lens module board fixed on the bottom of the radiator, the lens module board comprising a plurality of lenses covering the Light Emitting Diode light sources;
wherein the lenses comprise light distribution lenses configured to distribute light emitted from the Light Emitting Diode light sources in an asymmetric illumination profile.

2. The Light Emitting Diode luminairesas according to claim 1, wherein the radiator is equipped with a plurality of heat sinks with a gap between each two neighboring heat sinks.

3. The Light Emitting Diode luminaire according to claim 1, wherein the Light Emitting Diode luminaire is equipped with an adapter assembly, wherein one end of the adapter assembly is fixed on the radiator, and when in use the other end of the adapter assembly is fixed with the outside.

4. The Light Emitting Diode luminaire according to claim 3, wherein the adapter assembly comprises a first adapter and a second adapter, wherein the first adapter is fixed on the radiator, and the first adapter is rotatably engaged to the second adapter, and when in use the second adapter is fixed with the outside.

5. The Light Emitting Diode luminaire according to claim 4, wherein the first adapter and the second adapter have tooth structures through which the two adapters are rotatably engaged with each other.

6. The Light Emitting Diode luminaire according to claim 4, wherein the first adapter is fixed on the radiator by a silicone pad, and the first adapter connects to the second adapter by a silicone ring.

7. The Light Emitting Diode luminaire according to claim 4, wherein the first and second adapters together form a waterproof housing when the first and second adapters are engaged with each other through the tooth structures.

8. The Light Emitting Diode luminaire according to claim 1, wherein the Light Emitting Diode luminaire further comprises an aluminum substrate, the Light Emitting Diode light sources all evenly distributed on the aluminum substrate which is fixed on the bottom of the radiator; wherein the number of the lenses on the lens module board is equal to the number of the Light Emitting Diode light sources; the lens module board covers the Light Emitting Diode light sources and is sealed by a waterproof ring.

9. The Light Emitting Diode luminaire according to claim 1, wherein the material of the radiator is aluminum or copper.

10. The Light Emitting Diode luminaire according to claim 1, wherein the power source is equipped with a lighting arrester.

11. The Light Emitting Diode luminaire according to claim 1, wherein the Light Emitting Diode luminaire is provided with a fixed adapter, one end of the fixed adapter fixed on the radiator and the other end of the fixed adapter fixed on the outside.

12. The Light Emitting Diode luminaire according to claim 1, wherein each of the Light Emitting Diode light sources is configured to emit light along a light emission axis, wherein at least one of the light distribution lenses is configured to distribute the light emitted from the corresponding Light Emitting Diode light source such that more light energy is concentrated on a first side of the corresponding light emission axis than on a second side of the corresponding light emission axis.
